(19) United States
(12) Patent Application Publication
(10) Pub. No.: US 2009/0080077 A1
(43) Pub. Date: Mar. 26, 2009

(54) OPTICAL ELEMENT HAVING ANTIREFLECTION FILM

(75) Inventor: JUIN-HONG LIN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/946,795

(22) Filed: Nov. 28, 2007

(30) Foreign Application Priority Data
Sep. 21, 2007 (CN) 200710201804.8

(51) Int. Cl. G02B 1/10

(52) U.S. Cl. 359/586; 359/359

(57) ABSTRACT

An optical element includes a substrate and an antireflection film coated on a surface of the substrate. The antireflection film includes a bottom layer, a range broadening layer, and a top layer in order from the substrate side. The bottom layer is formed using a middle refractive index material. The range broadening layer includes: a first layer formed using a high refractive index material; a second layer formed using a low refractive index material; a third layer formed using a high refractive index material; a fourth layer formed using a low refractive index material; and a fifth layer formed using a high refractive index material. The top layer is formed using a low refractive index material. Wherein, d=λ/(4×n), λ is a wavelength of incident light, n is a refractive index of the corresponding film material.

### TECHNICAL FIELD

The present invention relates to optical elements having antireflection films, particularly, to an optical element having an antireflection film with high transmittance in a wide wavelength range.

### DESCRIPTION OF RELATED ART

Up to now, antireflection films have been extensively used in optical or opto-electrical applications where it is desired or necessary to decrease reflection at an optical boundary between, for example, air and glass. Examples of such applications include a camera lens, a platen for a copying machine, a glass cover for equipment, a panel for a cathode ray tube, and display devices.

However, existing antireflection coating has quite a few drawbacks, such as transmittance reduction in ultraviolet and infrared bands near the visible light band, when applied to an optical element for use in the visible light band. For example, when antireflection coating is used on an optical device such as a camera, color may be changed in images.

What is needed, therefore, is an optical element having an antireflection film with high transmittance in a wide wavelength range.

### SUMMARY

In accordance with one present embodiment, an optical element includes a substrate and an antireflection film coated on a surface of the substrate. The antireflection film includes a bottom layer, a first layer, a second layer, a third layer, a fourth layer, a fifth layer, and a top layer in that order from the substrate side. The bottom layer with a thickness in a range from 0.95 d to 1.05 d is formed using a middle refractive index material. The first layer with a thickness in a range from 0.311 d to 0.343 d is formed using a high refractive index material. The second layer with a thickness in a range from 0.147 d to 0.163 d is formed using a low refractive index material. The third layer with a thickness in a range from 1.561 d to 1.725 d is formed using a high refractive index material. The fourth layer with a thickness in a range from 0.210 d to 0.232 d is formed using a low refractive index material. The fifth layer with a thickness in a range from 0.321 d to 0.355 d is formed using a high refractive index material. The top layer with a thickness in a range from 0.95 d to 1.05 d is formed using a low refractive index material. Wherein, d=λ/(4×n), λ is a wavelength of incident light, n is a refractive index of the corresponding layer.

### BRIEF DESCRIPTION OF THE DRAWING

Many aspects of the present optical element having antireflection film can be better understood with reference to the following drawings. The components in the drawing are not necessarily drawn to scale, the emphasis instead being placed upon clearly illustrating the principles of the present optical element. Moreover, in the drawings, like reference numerals designate corresponding parts throughout the several views.

FIG. 1 is a schematic, block diagram of an optical element according to a present embodiment.

FIG. 2 is a graph showing reflectance characteristics of an antireflection film coated on the optical element of FIG. 1.

### DETAILED DESCRIPTION OF THE EMBODIMENTS

Embodiments will now be described in detail below, with reference to the drawings.

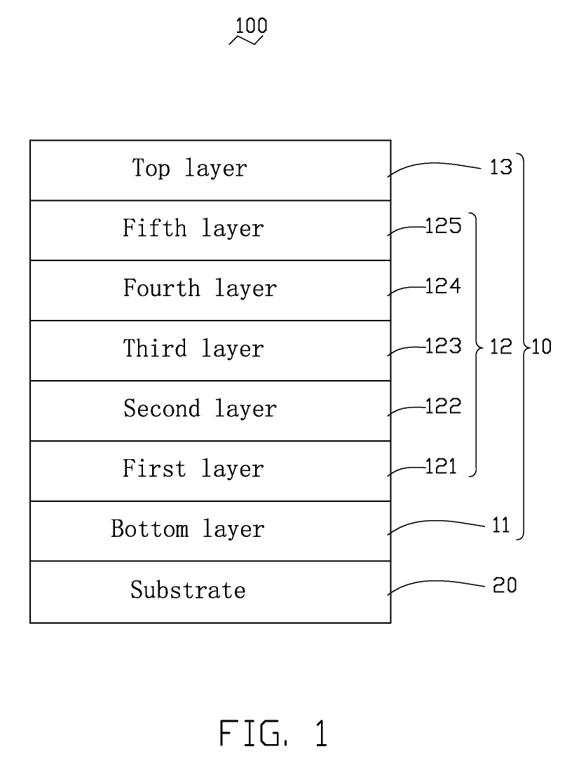

Referring to FIG. 1, an optical element 100, according to an embodiment, is shown. The optical element 100 includes a substrate 20 and an antireflection film 10 coated on a surface of the substrate 20. The optical element 100 can be an optical lens, a prism, and so on.

The material of the substrate 20 can be selected from glass or plastic. All of the light emitting surfaces and light incident surfaces of the substrate 20 can be coated with the antireflection film 10.

The antireflection film 10 includes a bottom layer 11, a range broadening layer 12, and a top layer 13. The bottom layer 11, the range broadening layer 12, and the top layer 13 are sequentially formed on a surface of the substrate 20.

The bottom layer 11 is formed using a middle refractive index material. In the present embodiment, a material with refractive index in a range from 1.6 to 1.7 is used as the middle refractive index material. The middle refractive index material can be Al₂O₃. In order to describe the physical thickness of films, a physical film thickness unit d is established, wherein d=λ/(4×n), λ is a wavelength of incident light, and n is a refractive index of a film material. The value of λ is in a range from 500 nm to 700 nm. In the present embodiment, the value of λ is 600 nm. The thickness of the bottom layer 11 is in a range from 0.95 d to 1.05 d. Preferably, the thickness of the bottom layer 11 is approximately 1 d.

The top layer 13 is formed using a low refractive index material. In the present embodiment, a material with refractive index in a range from 1.35 to 1.46 is used as the low refractive index material. The low refractive index material can be selected from a group consisting of MgF₂ and SiO₂. The thickness of the top layer 13 is in a range from 0.95 d to 1.05 d. Preferably, the thickness of the top layer 13 is approximately 1 d.

The range broadening layer 12 includes a first layer 121, a second layer 122, a third layer 123, a fourth layer 124, and a fifth layer 125 forming sequentially on a surface of the substrate 20. The first layer 121 with a thickness in a range from 0.311 d to 0.343 d is formed using a high refractive index material. The second layer 122 with a thickness in a range from 0.147 d to 0.163 d is formed using a low refractive index material. The third layer 123 with a thickness in a range from 1.561 d to 1.725 d is formed using a high refractive index material. The fourth layer 124 with a thickness in a range from 0.210 d to 0.232 d is formed using a low refractive index material. The fifth layer 125 with a thickness in a range from 0.321 d to 0.355 d is formed using a high refractive index material. In present embodiment, a material with refractive index in a range from 2.0 to 2.3 is used as the high refractive index material. The high refractive index material can be selected from a group consisting of TiO₂, Ta₂O₅, and Nb₂O₅. The low refractive index material can be selected from a group consisting of MgF₂ and SiO₂.

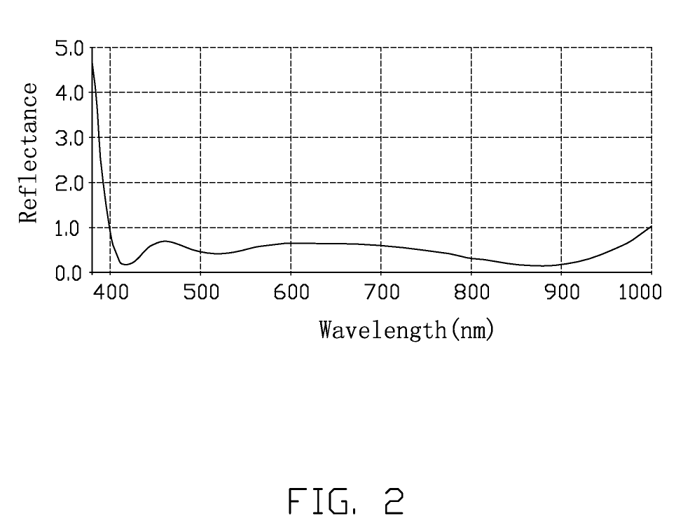

An example of the antireflection film 10 will be described below with reference to FIG. 2. It is to be understood that the invention is not limited to this example. A thickness of each layer was set as in table 1 by multiplying a predetermined coefficient of the film thickness so as to obtain desired optical characteristics.

TABLE 1

| Layers | material | thickness(d) |
|---|---|---|
| bottom layer | Al₂O₃ | 1 |
| first layer | TiO₂ | 0.327 |
| second layer | SiO₂ | 0.155 |
| third layer | TiO₂ | 1.643 |
| fourth layer | SiO₂ | 0.221 |
| fifth layer | TiO₂ | 0.338 |
| top layer | SiO₂ | 1 |

Referring to FIG. 2, a graph shows reflectance characteristics of an antireflection film 10 formed according to table 1. The abscissa of the graph represents wavelengths and the ordinate of the graph represent reflectance. From the FIG. 2, we can see that the reflectance of the antireflection film 10 exposed to wavelengths from 400 nm to 1000 nm is lower than 1%. So that, the antireflection film 10 has high transmittance in the visible light band, and the ultraviolet and infrared bands near the visible light band. Accordingly, when the optical element 100 having the antireflection film 10 coated thereon is used for an optical device such as a camera, problems with color change and the like will not occur.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An optical element comprising:
a substrate; and
an antireflection film formed on a surface of the substrate, the antireflection film comprising:
a bottom layer formed on the surface of the substrate, the bottom layer having a thickness in a range from 0.95 d to 1.05 d, and a first refractive index;
a first layer formed on the bottom layer, the first layer having a thickness in a range from 0.311 d to 0.343 d, and a second refractive index greater than the first refractive index;
a second layer formed on the first layer, the second layer having a thickness in a range from 0.147 d to 0.163 d, and a third refractive index less than the first refractive index;
a third layer formed on the second layer, the third layer having a thickness in a range from 1.561 d to 1.725 d, and a fourth refractive index greater than the first refractive index;
a fourth layer formed on the third layer, the fourth layer having a thickness in a range from 0.210 d to 0.232d, and a fifth refractive index less than the first refractive index;
a fifth layer formed on the fourth layer, the fifth layer having a thickness in a range from 0.321 d to 0.355 d, and a sixth refractive index greater than the first refractive index, and
a top layer formed on the fifth layer, the top layer having a thickness in a range from 0.95 d to 1.05 d, and a seventh refractive index less than the sixth refractive index,
wherein, d=λ/(4×n), λ is a wavelength of incident light, n is a refractive index of the corresponding layer.

2. The optical element as claimed in claim 1, wherein the thicknesses of each of the bottom layer and the top layer is 1 d.

3. The optical element as claimed in claim 1, wherein the thicknesses of the first layer, the second layer, the third layer, the fourth layer, and the fifth layer are 0.327 d, 0.155 d, 1.643 d, 0.221 d, and 0.338 d respectively.

4. The optical element as claimed in claim 1, wherein the refractive index of each of the first layer, the third layer, and the fifth layer is in a range from 2.0 to 2.3.

5. The optical element as claimed in claim 1, wherein each of the first layer, the third layer, and the fifth layer is comprised of a material selected from a group consisting of TiO₂, Ta₂O₅, and Nb₂O₅.

6. The optical element as claimed in claim 1, wherein the refractive index of the bottom layer is in a range from 1.6 to 1.7.

7. The optical element as claimed in claim 1, wherein the bottom layer is comprised of Al₂O₃.

8. The optical element as claimed in claim 1, wherein the refractive index of each of the second layer, the fourth layer and the top layer is in a range from 1.35 to 1.46.

9. The optical element as claimed in claim 1, wherein each of the second layer, the fourth layer and the top layer is comprised of a material selected from a group consisting of MgF₂ and SiO₂.

10. The optical element as claimed in claim 1, wherein λ is in a range from 500 nm to 700 nm.

11. The optical element as claimed in claim 1, wherein λ is 600 nm.
